(19) United States
(12) Patent Application Publication
(10) Pub. No.: US 2003/0227477 A1
(43) Pub. Date: Dec. 11, 2003

(54) Detecting compatibility of a computer system with a software download through the world wide web

(76) Inventor: Ketan Pushpakant Kadiwala, Pasadena, CA (US)

Correspondence Address: KETAN KADIWALA, 36811 Ashover Drive, FARMINGTON, MI, 48335, US

(21) Appl. No.: 10/161,703

(22) Filed: Jun. 5, 2002

(51) Int. Cl. G09G 5/00

(52) U.S. Cl. 345/748

(57) ABSTRACT

The invention allows a user to know to before downloading software over the web if their computer system meets the requirements of the software. The invention runs automatically within a web browser. It checks requirements by collecting detailed system information and comparing it to the requirements for the software entered in the HTML. This saves the user the time and effort of trying to download, install, and run an incompatible piece of software.

### RELATED PATENT APPLICATIONS

| | | | |
|---|---|---|---|
| 5881236 | March 1999 | Dickey | 709/221 |
| 6282712 | August 2001 | Davis et al. | 717/170 |
| 5832275 | November 1998 | Olds | 717/173 |
| 5752042 | May 1998 | Cole et al. | 717/173 |
| 5579509 | November 1996 | Furtney et al. | 703/27 |
| 6282711 | August 2001 | Halpern et al. | 717/175 |

### OTHER REFERENCES

“System Requirements, EFS”, http://www.uspto.gov/ebc/efs/downloads/systemreq.htm “Microsoft COM Specification”, http://www.microsoft.com/com/resources/comdocs.asp “ActiveX Controls”, http://www.microsoft.com/com/tech/ActiveX.asp

### Reference to Computer Program Listing Appendix

A computer program listing is included with certain support files. They have been submitted on two CD-R. An original and a duplicate.

The files included are:

| Name | Size | Description |
|---|---|---|
| CheckData.cpp | 546 | //configuration code |
| CheckData.h | 449 | |
| CheckInfo.cpp | 17505 | //system checking code |
| CheckInfo.h | 571 | |
| DrawResult.cpp | 1923 | //visual output code |
| DrawResult.h | 429 | |
| MsgLog.cpp | 499 | //user reporting/logging code |
| MsgLog.h | 350 | |
| Sec.cpp | 189 | |
| Sec.h | 6554 | //main component code |
| Sec.htm | 430 | //example HyperText Markup |
| | | Language (HTML) |
| StdAfx.cpp | 315 | |
| StdAfx.h | 929 | |
| Trace.cpp | 242 | //logging |
| Trace.h | 260 | |
| resource.h | 542 | |
| satl.cpp | 1930 | |
| satl.def | 216 | |
| satl.h | 5257 | //com object definition |
| satl.idl | 727 | |

### BACKGROUND OF THE INVENTION

The present invention relates to the installation of software downloaded through the World Wide Web (Web), and in particular the compatibility of that software with the downloading computer.

Downloading and installing software through the web can be a difficult task, especially for new or non-technology oriented users. There are a many things that need to work properly for software to be installed. This includes, being able to unpackage the software correctly, having the correct operating system, having correct hardware, having additional support software installed. These leaves many potential areas for failure when trying to download software through the web. The current invention allows to user to avoid the time and hassle of downloading and installing a software by knowing whether their system meets the softwares requirements.

Currently, in the most common case, when users download software through the web their browser retrieves the file over the web using HTTP, the file is stored on disk after which it is unpackaged and the installation program if needed is run.

Most often before downloading the user is advised of the “System Requirements” Here is an excerpt from the EFS system requirements, needed to run ePAVE.

Processor: Pentium 266 mHz minimum

Memory: 64 MB RAM minimum

Free Space: 42 MB minimum

Monitor Resolution: 800 by 600 minimum

Operating System: Windows 95 (Service Release 1 or higher) or Windows 98 or Windows/NT® (Service Pack 3 or higher) or Windows 2000

Browser: Microsoft Internet Explorer 5.01 or higher (Internet Explorer 5.5 recommended)

TIFF Viewer Plug-In

Internet Connection: 56 Kbps or faster

The user is expected to understand these requirements, to know the capabilities of their computer system, and decide if the software will work or not. Even for advanced users this can prove a difficult task, since there are unstated underlying assumptions on which these requirements are based. Such things as the file system format can change the disk space requirement significantly, or the type of memory installed can have a significant impact on performance. This method of determining compatibility, although the most common, contains serious disadvantages for the user.

There have been various strategies to make this simpler for the user, more advanced websites use the HTTP request's “User-Agent” header in order to automatically redirect users to the right download link based on information in that field, this does not work for browsers that do not report the operating system in the user-agent string, and this essentially only relieves the user of the burden of understanding the operating system requirement.

A very few websites have gone further, such a Microsoft.com which contains an ActiveX control which finds what software is installed on the system and makes recommendations of other software to install. This works for an isolated group of software that is designed to run together.

Other software relies on the installation process. Before the software is the installation software flags any problem with the system. This a better solution since it can detect more problems, but still requires the user to spend time downloading the software which can be a time consuming task. Also in some instances the installation software itself may not run.

### BRIEF SUMMARY OF THE INVENTION

The invention allows a user to know before downloading software whether their system meets the requirements of the software and therefore will most likely be compatible with it. This saves the user the time of downloading, and potential corruption of their system from attempting to install a piece of software.

The invention is a component of software that runs within the execution environment of a web browser. It is refered to in Internet Explorer as a control , and in Netscape, as a plugin. Other browser exists with other terminology and interface, but the concept is the same. The software is automatically downloaded and run when a user downloads a web page which contains the correct html.

To give meaningful results specific html must be used to reference the control, and also to input the system requirements of the software. Once this is done the control can compare these against the downloading system and display the result. A check mark is displayed if everything is a ok, and a red X if there is a a problem. Furthermore there is an error log that is created and which can be viewed by clicking on the red X. It informs the user of what requirement(s) their system did not meet.

### BRIEF DESCRIPTION OF THE DRAWINGS

FIG. 1 Displays the client-server system in which the invention is used, and shows what the invention looks like to the user

FIG. 2 Displays a flow control diagram for the main detection portion of the invention

### DETAILED DESCRIPTION

The invention is a piece of software that is automatically downloaded and run on the users computer when they request a web page.

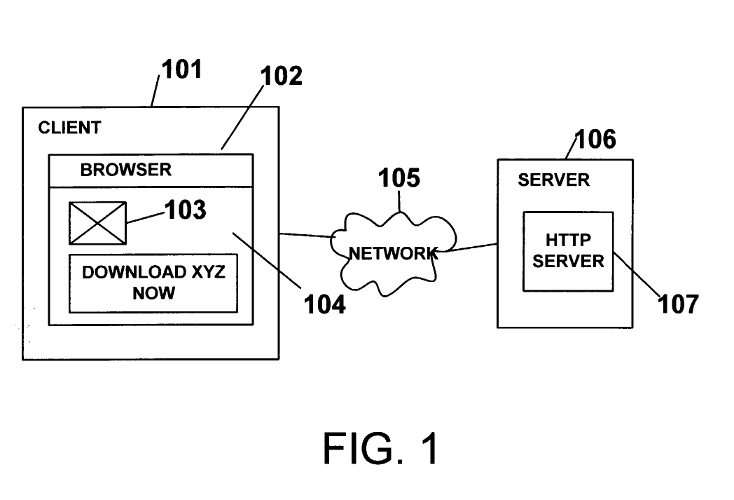

FIG. 1 shows the system in which the invention can be used. A user's computer 101 along with software capable of connecting to the World Wide Web, commonly known as a web browser 102, connects to a remoter server 106 through a network 105 with a HTTP server 107 running. The web browser requests a HyperText Markup Language (HTML), document. The server responds with the document 104, which contains special HTML used to tell the web browser where to find the software that comprises the invention, and what the configuration information is. For the results of the invention to be meaningful, the configuration information must correspond to the necessary requirements of a computer system to run the software.

Example HTML to locate and configure an ActiveX control implementation is

<OBJECT ID=“Sec”CLASSID=“CLSID:D1482FFF-77A7-445F-B1FA-23979E61E06B” codebase=“/”>

<param name=XSIZE VALUE=“4000”>

<param name=YSIZE VALUE=“4000”>

<param name=DIRECTX_VERSION VALUE=“6”>

<param name=SCREEN_X VALUE=“640”>

<param name=SCREEN_Y VALUE=“480”>

<param name=MEMORY VALUE=“1000”>

<param name=DISK VALUE=“10000”>

<param name=MAJOR_OS VALUE=“5”>

<param name=MINOR_OS VALUE=“0”>

<param name=“PLATFORM_OS” VALUE=“0”>

<param name=“PROC_ARCH” VALUE=“0”>

<param name=“PROC_LEVEL” VALUE=“6”>

</OBJECT>

The design of the invention allows more system checks to be added easily.

The currently supported ones are shown above and are

DIRECTX_VERSION—The version of Microsoft DirectX that is installed on the system

SCREEN_X—Screen Resolution Horizontal pixels

SCREEN_Y—Screen Resolution Vertical pixels

MEMORY—memory in kilobytes

DISK—disk space in kilobytes

MAJOR_OS—os version id

MINOR_OS—os sub version id

PLATFORM_OS—os platform is

PROC_ARCH—id for processor architecture (Intel, ALPHA, 68K)

PROC_LEVEL—depends on PROC_ARCH, but for Intel reprsenrs 386,486, Pentium and so on.

Once this HTML is processed by the browser it will retrieve the control, and possibly show the user a security warning before executing it. Depending on whether the system meets the requirements or not, in the display area of the control 103, an image of a green check mark or red “X” will be shown.

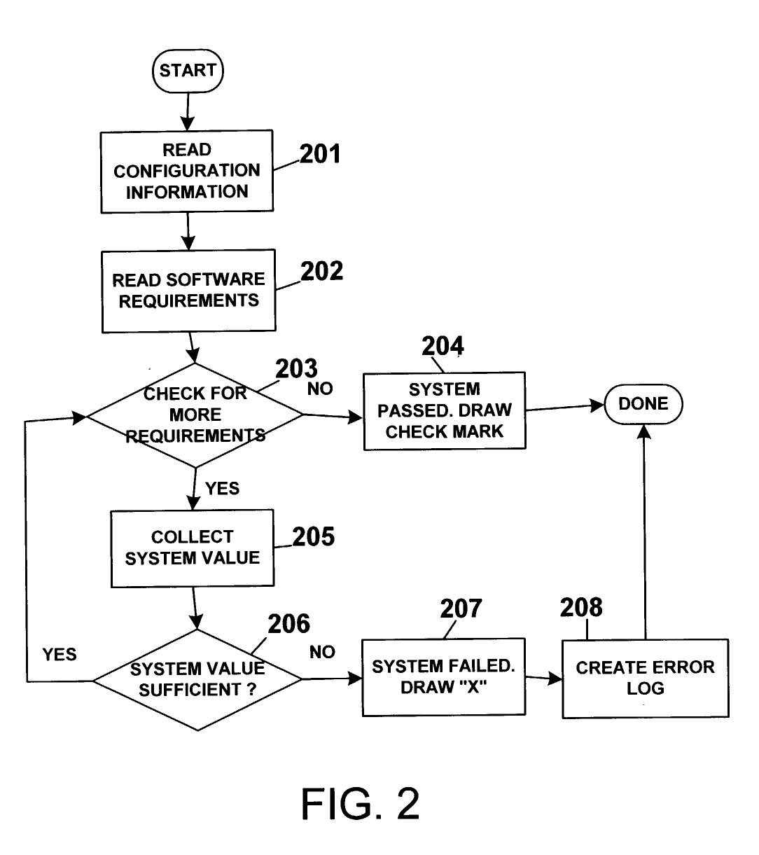

FIG. 2 shows the overall operation of the invention when it is executed by the browser. At step 201 the invention reads in the configuration information, this currently only consists of the XSIZE and YSIZE parameters, which define the size of the actual invention within the web page. This allows the implementer to change the visual size of invention in order to suit his needs for that particular HTML page.

At step 202 the invention reads in all the system requirements supplied in the param tags. The requirements specified are absolutely critical to the detection process results being meaningful. The control is in essence a comparison engine. It is the responsibility of the web page developer, or developer of the software to supply the correct minimum requirements for the software and generate the correct html for this.

In steps 203, 205, and 206 the invention cycles through all the requirements testing each one individually. If any time the system does not meet one of the requirements the process stops and the failure symbol is drawn, a red “X” 207. An error log is also created that documents what test failed 208. This can be accessed by the user by clicking with the primary mouse button anywhere inside the visual area of the control. If after checking all the requirements, there have been no failure then the invention proceeds to step 204 since the system must meet every requirement and a big green check mark is displayed.

What is claimed is:

1. A method of automatically determining if a computer system meets the requirements for a piece of software before downloading over the World Wide Web, comprising:
reading configuration information embedded in the HTML containing the software download;
collecting system information;
comparing this information to the configuration;
showing a visual display of the result of the test;

2. The method of claim 1 where the step of showing the visual display includes having an adjustable viewing area

3. The method of claim 2 where the step of showing the visual display further includes a log showing the specific failure (if any) of the system along with the required valued.

4. The method of claim 1 where the step of collecting system information includes
a. collecting the the version of Microsoft DirectX that is installed on the system
b. collecting the amount of memory in the system
c. collecting the amount of hard disk space in the system
d. collecting the operating system type
e. collecting the microprocessor type
